(19) United States
(12) Patent Application Publication
(10) Pub. No.: US 2013/0036787 A1
(43) Pub. Date: Feb. 14, 2013

(54) Pipe expander

(71) Applicant: Arthur Eugene Johnson, Prineville, OR (US)

(72) Inventor: Arthur Eugene Johnson, Prineville, OR (US)

(21) Appl. No.: 13/159,407

(22) Filed: Aug. 8, 2011

(51) Int. Cl. B21D 3/16; F16L 55/18

(52) U.S. Cl. 72/452.4

(57) ABSTRACT

The expander is used in restoration of damaged irrigation pipe sliding the pipe over the Expander reaching the flattened point in the pipe force is applied to the horizontal slider moving the upper body to push the pipe to its original shape. Obviously, the expanding head may be of varied sizes, depending upon the size requirements of the work piece.

### CROSS-REFERENCE TO RELATED APPLICATIONS

Not Applicable

### FEDERALLY SPONSORED RESEARCH OR DEVELOPMENT

Not Applicable

### BACKGROUND

This elongated type expander can be used to repair dented pipe and in so doing can save about 80% of damaged irrigation pipe from being recycled.

### SUMMARY OF THE INVENTION

Pipe Expander of elongated cam type for use in restoring damaged pipe.

### BRIEF DESCRIPTION OF THE VIEWS OF THE DRAWINGS

FIG. 1 shows the side view.

Section 2 shows a cut away view looking down from the top.

### DETAILED DESCRIPTION

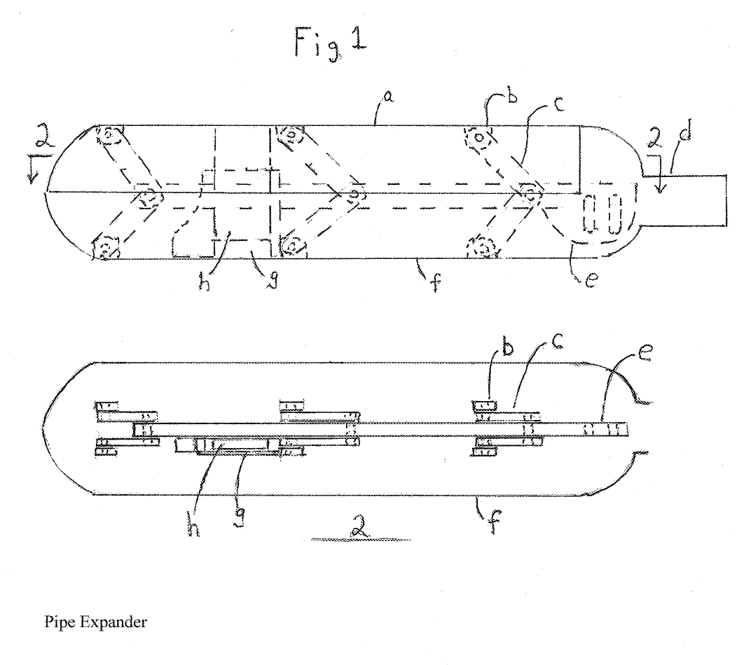

Looking at FIG. 1 the view is of the side showing the internal parts the out side of the expander is made from standard tube steel, (for this example we will say the expander is 2′ long) the expander is cut down the length 22″ then cut across the top to separate A from F the front and rear of the tube are coned and the connection end has a insert D for a hollow connector and push rod.

Looking at the internal parts and how they work E is made of ½″ plate with machined slots for connecting rod attachment. When force is applied to E it moves C forward pushing on B forcing F and A apart, while G and H hold A and F in alignment. C is made of ½″ Flat bar, B is made of ⅜″ Flat bar, H is made of ¼″ Flat bar and G is made up of 2 sides 3/16 Plate and 2 ends of ¼″ Flat bar to make a sleeve for H to slide in. H and B are connected to A by means of a welded joint. G and B are connected to F by a welded joint. All other connections are made by connecting pins/bolts.

Obviously the expander will need to be of varying diameter, changing the length of parts needed to do the work required for different size pipe (3″-12″ pipe for example).

While the invention is susceptible to various modifications and alternative forms, certain specific embodiments thereof have been shown by way of example in the drawings which have be described in detail herein. It should be understood, however, that it is not intended to limit the invention to the particular forms disclosed but, on the contrary, the intention is to cover all modifications, equivalents and alternatives falling within the spirit and scope of the invention.

What is claimed is:

1. A pipe expander of elongated type for use on expanding irrigation aluminum pipes, Comprising of: A and F supporting frame; cone supporting at end for push rod connection D, Cams C, vertical slider G and H, Horizontal slider E, as shown in FIG. 1.

2. By pressure applied to E the cams rotate moving the upper body A to expanded position while the vertical slider G and H holds upper body in alignment as slider E moves forward the vertical slots machined in E allow for movement of the slider in a upwards motion.
